(19) United States
(12) Patent Application Publication
(10) Pub. No.: US 2026/0368538 A1
(43) Pub. Date: Nov. 19, 2026

(54) METHODS AND SYSTEMS FOR AN ELECTRONIC PLATFORM IMPLEMENTING THE SIMULTANEOUS GENERATION OF HARDWARE-BUFFERED EVALUATION OF INDEPENDENT HUMAN AND HIDDEN AI WORKFLOWS

(71) Applicant: Soham Pranav Shah, Redwood City, CA (US)

(72) Inventor: Soham Pranav Shah, Redwood City, CA (US)

(73) Assignee: Ema Unlimited Inc., Mountain View, CA (US)

(21) Appl. No.: 19/458,883

(22) Filed: Jan. 25, 2026

Related U.S. Application Data
(63) Continuation of application No. 18/983,794, filed on Dec. 17, 2024.
Application No. 18/983,794 is a continuation of application No. 18/610,276, filed on Mar. 20, 2024.

(51) Int. Cl. G06N 3/091

(52) U.S. Cl. CPC G06N 3/091

(57) ABSTRACT

Methods and systems for multi-agent query processing to facilitate the parallel generation of independent human and AI agent workflows within a synchronized processing window are described. An independent, unbiased AI agent may evaluate these distinct response threads during a hardware-managed buffering period to select a final response, which may comprise a segmented combination of both inputs. The system may integrate hardware-rooted interruption detection, such as by utilizing peripheral sensors, biometric data, and system resource analysis, to determine the active state and independent cognizance of the human agent. In some embodiments, a hardware-isolated sandbox may be used for simulation of AI workflows, including simulated cursor movements, to guide human decision-making without committing live changes. Final responses may feature visual differentiation and interactive toggles tools for segment-by-segment adoption and real-time agent ranking updates. This architecture may optimize computational efficiency while ensuring technically accurate and empathetic communications.

### CROSS-REFERENCE TO RELATED APPLICATIONS

This application is a continuation of U.S. patent application Ser. No. 18/983,794, filed Dec. 17, 2024, which is a continuation of U.S. patent application Ser. No. 18/610,276, filed Mar. 20, 2024, the disclosures of these applications are incorporated herein by reference in their entirety.

### FIELD OF INVENTION

Embodiments of the present disclosure relate to an electronic platform for multi-agent response evaluation where a response to a query is simultaneously generated by human and artificial intelligence (AI) agent(s) and hardware-rooted monitoring, interruption detection, and segmented attribution logic is used to select, combine, and rank responses for optimized user interaction. Embodiments of the present disclosure also relate to use of hierarchical virtual tokens and biometric hardware sensors to establish a technical framework for authenticating agent identity and accurately weighting and attributing performance in a human-AI agent collaborative environment.

### BACKGROUND

Modern enterprise environments increasingly rely on communication platforms to facilitate information exchange between users and service providers. In current industrial practices, when a user submits a query to an electronic platform, the response is typically generated by either a human agent, such as a call center agent in a call center, or an artificial intelligence (AI) agent, such as a large language model (LLM) or chatbot. While both human expertise and algorithmic processing offer unique benefits, current systems generally operate these mechanisms in isolation or in a basic serial hand-off manner, failing to leverage the simultaneous strengths of both agents in real-time.

Despite the widespread use of these independent channels, several systemic inefficiencies and technical gaps remain unaddressed in the current systems used. In one instance, a limitation of current systems is the lack of a technical framework for multi-source data synchronization during the window of query processing. Conventional platforms are typically designed to wait for a single output from a designated source, lacking the internal buffering logic or hardware-governed timing to manage a data stream, let alone be able to even use or compare multiple incoming data streams for a single request. Because these systems are designed for linear execution, they cannot effectively reconcile data from different processing entities that may operate at different latencies. This results in a siloed response environment where the system is technically incapable of identifying or extracting the most accurate portions of a response from one source and merging them with the most empathetic or specialized portions from another.

In another instance, existing systems struggle with the technical challenge of active-state monitoring at the human-computer interface. Current platforms generally rely on binary completion flags or simple arrival of data to determine if a task is finished, which creates a significant technical disconnect between the agent's physical activity and the system's logic. Because these platforms lack hardware-integrated awareness, such as real-time monitoring of peripheral activity, system resource utilization, or physiological engagement, the system remains blind to the actual work-state of the human agent during the period between query receipt and response delivery. This inability to technically perceive ongoing hardware-level engagement often results in premature resource de-allocation or a failure to synchronize the digital environment with the physical reality of the agent's workflow, leading to fragmented system performance.

In yet another instance, there is a lack of granular performance attribution tied to specific hardware and software interactions. When a final response is delivered to a user, current systems generally lack the data structures to track exactly which specific segments of that response were derived from which specific processing cycles or identities. This is particularly problematic when a response is the result of collaborative efforts or external consultations. Without a method to tag or tokenize specific segments of a response at the point of origin, the system may not be able to provide a fair or accurate ranking of performance.

As such, there is a need for an improved system and method that utilizes hardware-integrated monitoring and granular attribution logic to dynamically synchronize, evaluate, and combine multi-agent outputs into a high-fidelity final response.

### BRIEF DESCRIPTION OF THE DRAWINGS

The various objects and advantages of the disclosure will be apparent upon consideration of the following detailed description, taken in conjunction with the accompanying drawings, in which like reference characters refer to like parts throughout, and in which:

FIG. 1 is a flowchart of an example of a process for simultaneously generating human and AI agent responses for a live query and generating a final response, in accordance with some embodiments of the disclosure;

FIG. 2 is a flowchart of an example of a process for parallel generation of responses and use of hardware-managed buffering period to synchronize and score agent responses, in accordance with some embodiments of the disclosure;

FIG. 3 is a flowchart of an example of a process for identifying inaccuracies in a human agent response and automatically correcting the inaccuracies to generate a modified response, in accordance with some embodiments of the disclosure;

FIG. 4 is a flowchart of an example of a process for task completion and interruption detection, utilizing various hardware components, to determine the active state of a human agent, in accordance with some embodiments of the disclosure;

FIG. 5 is an exemplary illustration of a human agent being monitored by integrated hardware, to evaluate active state of human agent and/or generate tokenized data, in accordance with some embodiments of the disclosure;

FIG. 6 is a flowchart of an example of a process for detecting inter-human agent consultation and applying weighted attribution to individual agent profiles, in accordance with some embodiments of the disclosure;

FIG. 7 is a flowchart of an example of a process for shifting evaluation criteria based on query nature, task importance, and/or user role, in accordance with some embodiments of the disclosure;

FIG. 8 is a block diagram of an exemplary user interface system 800 illustrating the visual differentiation of response segments and the provision of an interactive toggle for segment-by-segment response adoption, in accordance with some embodiments of the disclosure;

FIG. 9 is a diagram illustrating the combination logic engine used for merging segmented portions of an original human agent response and an original AI agent response into a final combined response, in accordance with some embodiments of the disclosure;

FIG. 10 is a flowchart of an example of a process 1000 for ranking an agent based on user adoption and interaction with response segments, in accordance with some embodiments of the disclosure;

FIG. 11 is a block diagram of computing device architecture for performing the embodiments and processes discussed herein, in accordance with some embodiments of the disclosure; and

FIG. 12 is a detailed hardware architecture diagram illustrating the integration of hardware sensors, system memory modules, and agent evaluation logic for performing the embodiments and processes discussed herein, in accordance with some embodiments of the disclosure.

### DETAILED DESCRIPTION

In accordance with some embodiments disclosed herein, some of the above-mentioned limitations of traditional query-handling systems are overcome by an electronic platform configured to facilitate simultaneous, parallel execution of response generation by multiple independent agents. Upon receiving a live query, the system triggers a concurrent workflow where both a human agent and an artificial intelligence (AI) agent process the same query to determine next steps in the workflow and to provide an end or final result, i.e., the final answer or solution to the query. To ensure an objective evaluation, the AI agent's processing is initially hidden from the human agent. An independent, unbiased AI orchestrator, operating as a separate entity from the responding agents, evaluates the resulting human agent response (HAR) and the AI agent response (AAR). This evaluation often occurs during a hardware-managed buffering period, specifically calibrated to synchronize the two data streams without introducing perceptible latency to the end user.

In some embodiments, to establish a high-fidelity technical framework for determining agent engagement, the system integrates a hardware-rooted interruption and task completion detection module. When the evaluation module detects a pause in human agent activity, it initiates a multi-modal analysis of hardware signals to differentiate between a temporary wait-state and true task abandonment, or task completion. In some embodiments, this includes monitoring cursor movement patterns, analyzing CPU and RAM usage spikes indicative of research, and tracking application focus. Furthermore, the system may ingest biometric data from integrated hardware sensors, such as laptop camera gaze tracking, heart rate or sweat gland data from a wearable device (e.g., a Fitbit or smartwatch), physiological signals from secondary mobile devices, or camera monitoring via a camera embedded in electronic devices, such as laptop computer, home assistants, security cameras, or smartphones. This hardware-integrated logic allows the system to accurately determine when to hold the evaluation buffer to capture the human's complete performance versus when to move forward with an AI-generated alternative.

In some embodiments, the selection of the final response is governed by a dynamically shifting quality threshold that is recalculated based on the specific risk profile of the query. For instance, the system may automatically elevate the required accuracy threshold for critical or important enterprise tasks, or tasks that are categorized above a certain threshold, such as quarterly profit reporting or regulatory compliance queries, while utilizing a lower threshold for routine information technology (IT) support. Additionally, the system may provide for collaborative attribution logic; in scenarios where a human agent consults a secondary agent, another AI agent, or supervisor. When such collaborative attribution logic is used, the unbiased AI agent may monitor the workflow step tagging to ensure that weighted credit is accurately distributed among the contributing agents. This prevents the inflation of a primary agent's profile for segments derived from consultative input. For example, if a human agent consults an AI agent or platform for help with a segment, the credit for that consulted segment may be attributed to the source of the help rather than the human agent.

In some embodiments, the system further enables the generation of a hybrid combined response by merging segmented portions of both the HAR and AAR. In this embodiment, a combination logic engine may be used to parse responses into distinct segments, identifying key segments based on a human agent's expertise or title (e.g., a CEO or VP) and merging them with non-key segments provided by the AI agent. During this process, the system may apply rules to ensure the resulting output is logically coherent and prevents the delivery of disjointed or contradictory opinions. The AI agent may also act as a corrective layer, automatically updating inaccurate or outdated technical data within a human's response before the final output is displayed on the user interface.

In some embodiments, the user display interface is configured to provide visual transparency and interactivity regarding the source of the data. The final response may utilize color-coding, highlighting, shading, unique font style, or other visually distinguishing indicators, to distinguish between human and AI-generated segments of the response. An interactive toggle feature may be provided that allows the end user to hover over specific segments and switch back and forth between HAR and AAR versions or even request a third option from a supervisor's expert guidance. This user interaction creates a real-time feedback loop; for example, if a user requests clarification on an AI segment that leads to a response more closely aligned with the human's original input, the system automatically decreases the AI agent's rank while increasing the human agent's rank in the global database.

In some embodiments, advanced training and simulation modes may be used to optimize future performance. In one instance, a picture-in-picture simulation window may be provided to a human agent, showing a background execution of what the AI would do next in a workflow, including simulated cursor movements, without actually committing the changes. Furthermore, agents may be engaged in head-to-head gamified challenges, where the system evaluates their performance on a segment-by-segment basis even in a competitive environment, prior to the agents actually executing the workflow to respond to the query. By doing this, it may ensure that the most proficient segments are always prioritized for the end user, while providing personalized feedback and learning resources to the agents to improve subsequent query responses.

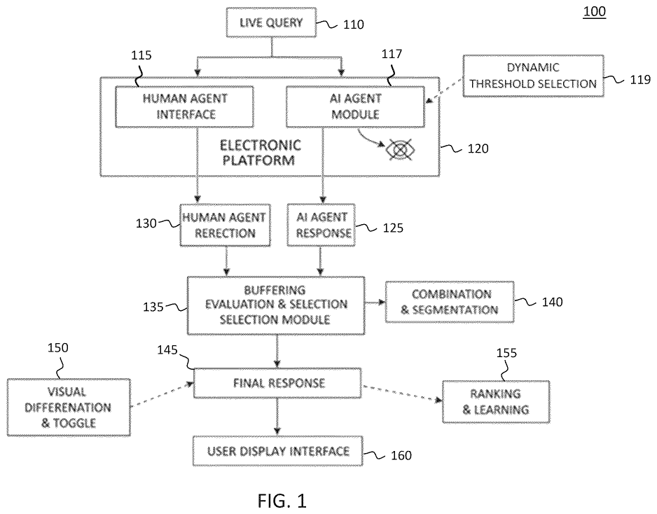

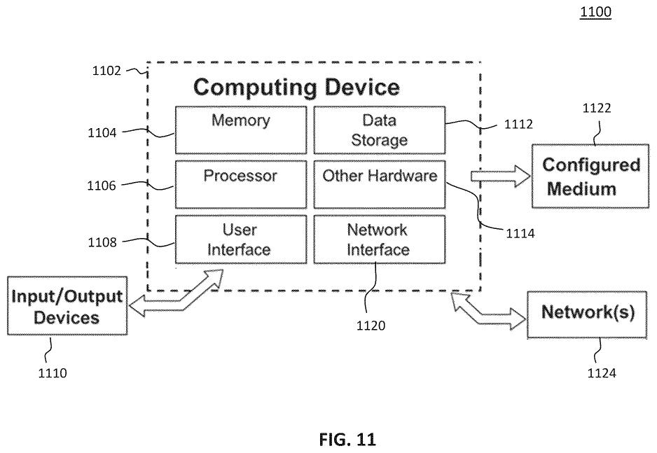

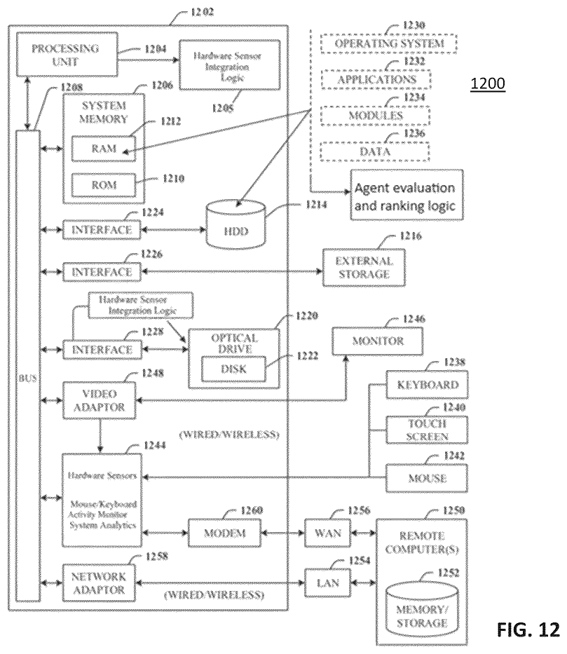

Turning now to the figures, FIG. 1 is a flowchart of an example of a process 100 for simultaneously generating human and AI agent responses for a live query and generating a final response, in accordance with some embodiments of the disclosure. Process 100 may be implemented, in whole or in part, by computing devices and hardware architecture such as those depicted in FIG. 11 and FIG. 12. One or more blocks of FIG. 1 may be saved to memory or data storage as instructions executed by processing circuitry to implement the described multi-agent orchestration.

At block 110, in some embodiments, a live query may be received on the electronic platform 120. The live query may represent a real-time request for information, such as a support ticket, or a complex technical problem submitted by an end user. For example, in an enterprise environment, the live query 110 may involve a critical financial request, such as “What are our reported quarterly profits for the Asia sector?” Upon receipt, process 100 may be initiated, which may include executing parallel processing threads to address the query through both human and AI agent (machine intelligence).

At block 115, in some embodiments, the live query may be directed to a human agent interface. This interface may allow a human agent, such as a call center specialist or a domain expert, to begin generating a response. Simultaneously, at block 117, the query may be processed by an AI agent module, which may utilize one or more Large Language Models (LLMs) to generate a machine-driven response. In one embodiment, the AI agent response 125 may be generated in the background and may be hidden from the human agent, such as at the interface 115, to ensure that the human agent's execution, input, and response, is original and not biased by the AI's suggestions.

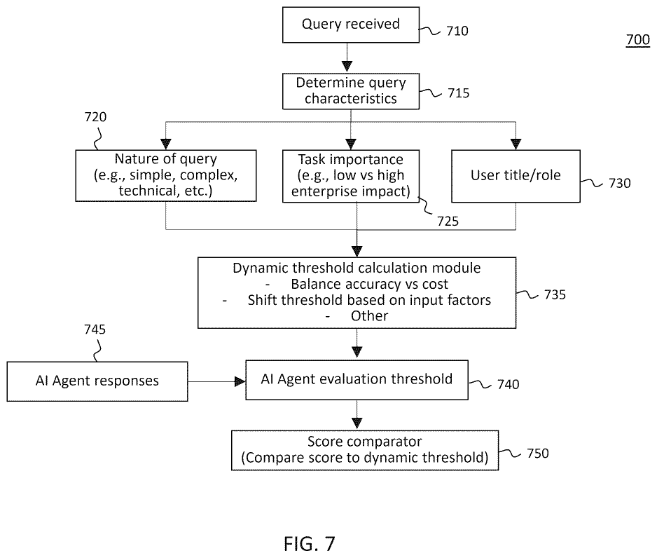

At block 119, in some embodiments, a dynamic threshold selection module may be used to determine the quality requirements for the generated responses. As further detailed in FIG. 7, this threshold may not be a fixed threshold but may shift dynamically based on the nature of query 110, the importance of the task, and the role of the user asking the question. For example, if a CEO is asking a high-stakes regulatory question, the dynamic threshold selection 119 may be set to an extremely high accuracy level, whereas a routine IT task, such as cleaning up cache, may utilize a lower threshold to prioritize speed and cost over exhaustive verification.

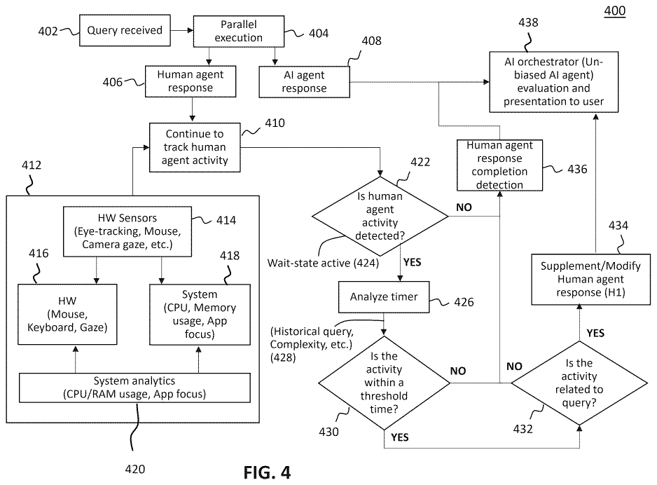

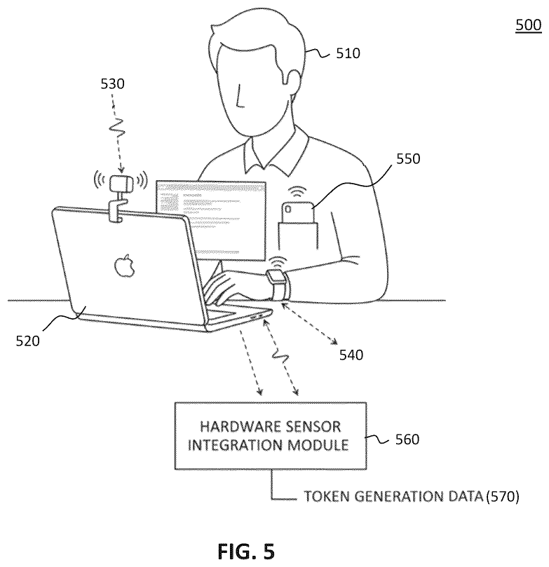

At block 130, in some embodiments, the human agent may generate a human agent response (HAR). While the human agent is generating the response, the system may monitor only the processing or workflow steps taken by the human agent, responses for each step, and/or the final text but also monitor the human's activity during the generation process. As described in further detail in FIG. 4 and FIG. 5, the system may use interruption detection and hardware-integrated monitoring using one or more devices. For instance, the system may use laptop cameras, smartwatches, and system analytics to determine if the human has truly finished the task or is merely in an interim wait-state. By performing such a check, the system may ensure that it captures a complete performance by the human agent rooted in hardware signals before moving to evaluation.

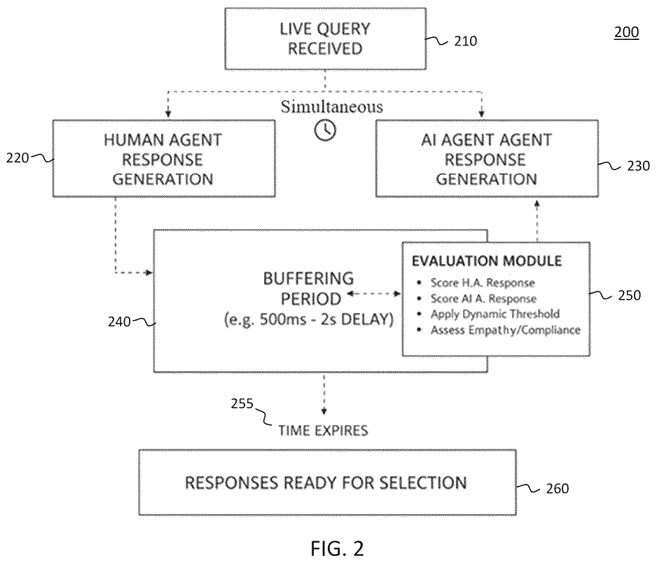

At block 135, in some embodiments, a selection module may be used to perform buffering, evaluation, and selection of the responses. As depicted in further detail in FIG. 2, this block manages a hardware-governed temporal window or buffering period (e.g., a 500 ms to 2 s delay or another predetermined time threshold) to synchronize the human and AI data streams. During this period, an independent and unbiased AI agent, which may be kept blind to the source of each response, may be used to evaluate both inputs against the dynamic threshold based on empathy, compliance, user comprehension, and any other factors configured for evaluation.

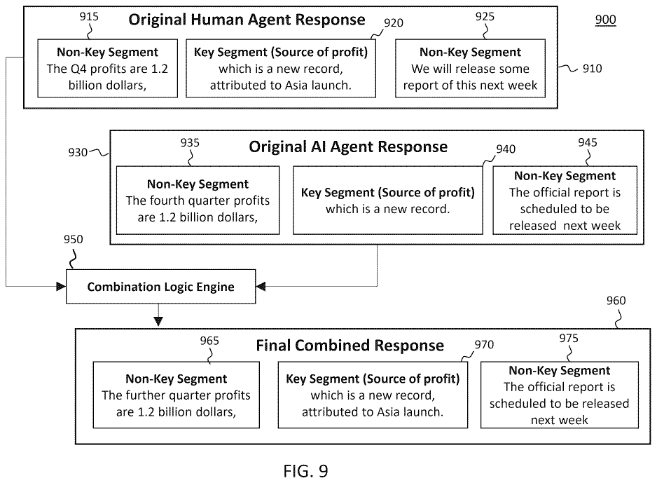

At block 140, in some embodiments, a combination and segmentation module may be used to determine if a hybrid response can be used. Rather than choosing one response in its entirety, the system may parse the responses into segments. As described in FIG. 9, this may involve the combination logic engine to merge key segments of the response identified from the human agent's expertise with non-key segments from the AI agent to ensure the final output is logically coherent and flows properly. Although references are made to key and non-key segments, other rules and configurations may also be developed automatically to determine which segment of the response to adopt from which agent, e.g., human or AI agent.

At block 145, in some embodiments, the final response may be generated. This response may be the original HAR, the original AAR, or the segmented combination from block 140. The system may provide the resulting modified response such that inaccuracies or outdated info in the human agent's response are automatically corrected by the AI agent module 117 before delivery.

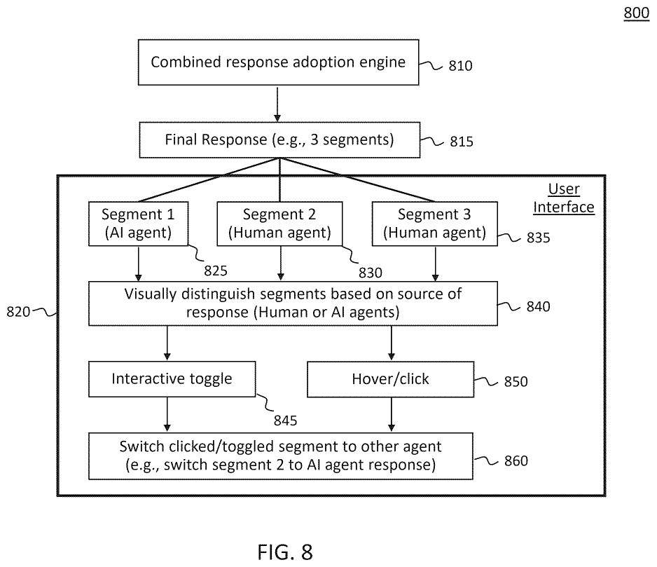

At block 150, in some embodiments, visual differentiation and toggle options may be applied to the final response 145. As further detailed in FIG. 8, the response may be color-coded, highlighted, bolded, or visually distinguished in other manners to identify the source agent, e.g., human or AI agent. In some embodiments, the system may provide an interactive option to allow the user to hover over a segment and toggle back and forth between the human and AI versions of the response or even switch to a supervisor's expert guidance. As such, the end user may have an option of selecting some human agent segments and some AI agent segments in the final response by toggling back and forth to their desire.

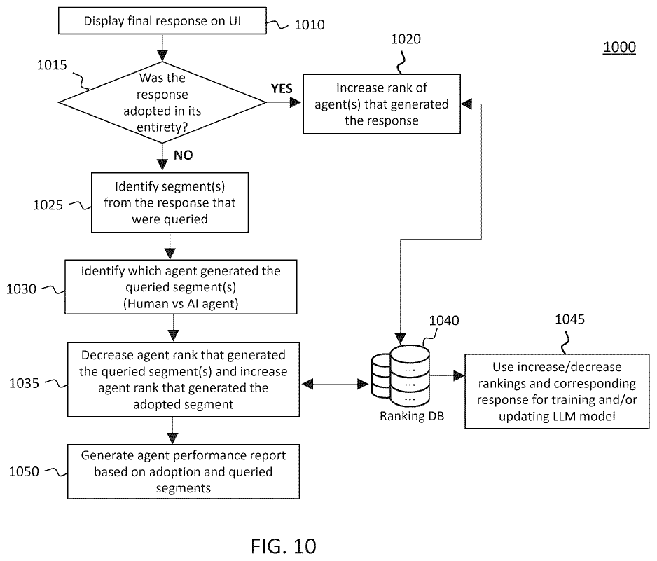

At block 155, in some embodiments, a ranking and learning module may be used to process user feedback to update agent profiles. As further detailed in FIG. 10, if a user accepts a response or toggles to a specific segment, the system may adjust the ranking of the respective agent in the Ranking DB. This data may subsequently be used for further training and optimization of the responding LLM models. For example, if the end user accepts all segments of the human agent response, this may be an indication that the end user was satisfied with the human agent's response and accordingly the human agent's ranking may be elevated. On the other hand, if the end user does not accept the final response, all segments of the human agent response, or any one segment, and queries for clarification, or further understanding, or change in answer, this may be an indication that the end user was not satisfied with the human agent's response and accordingly the human agent's ranking may be downgraded, such as for the entire response or for just the segment queried. If in response the human agent provides a clarification that is acceptable, then some or all of the human agent ranking may be recovered. Likewise, if the end user toggles from a human agent response for a particular segment and accepts the AI agent's response for that segment, this may be an indication that the end user was satisfied with the AI agent's response for than segment Ober human agent's response and accordingly the AI agent may be credited for that segment and their ranking may be elevated.

At block 160, in some embodiments, the final response may be displayed on the user display interface. The end user may receive the response as a seamless experience where the background evaluation and parallel processing remain hidden unless visual differentiation 150 is enabled.

In another embodiment, system 100 may provide a picture-in-picture (PiP) simulation window to the human agent. This allows the human agent at interface 115 to request a background simulation of what the AI would do next in a workflow, including simulated cursor movements and logic, without actually executing the changes until the human agent accepts the guidance.

In yet another embodiment, the system may engage the human and AI agents in a head-to-head gamified challenge to determine the best answer, which may be before determining which agent is more suitable for the task. Even if the AI agent wins the overall challenge, the system may identify specific preliminary segments that the human agent answered better and incorporate those into the final combined response 145.

FIG. 2 is a flowchart of an example of a process for parallel generation of responses and use of hardware-managed buffering period to synchronize and score agent responses, in accordance with some embodiments of the disclosure. Process 200 may be implemented, in whole or in part, by computing devices and hardware architecture such as those depicted in FIG. 11 and FIG. 12.

In some embodiments, process 200 may be used to establish a concurrent workflow where human and machine intelligences operate in tandem, governed by a strategic temporal buffer that allows a system orchestrator to reconcile, evaluate, and rank multiple data streams before they are finalized for user delivery.

At block 210, in some embodiments, a live query may be received by the electronic platform. This query may be a triggering event for the initiation of simultaneous processing threads. In one embodiment, the system may identify specific metadata or enterprise risk factors associated with the query to prepare the downstream evaluation module for specific scoring parameters.

At block 220, in some embodiments, human agent response generation may be initiated. During this stage, the human agent interface may receive the query and allows a human agent/specialist to begin executing a workflow, such as a first step of the workflow, plan the workflow, or start drafting a response. Throughout this generation phase, the system may utilize hardware-rooted monitoring to establish the active-state of the human agent. For instance, in one embodiment, the system may monitor the human agent's activity. For instance, the system may monitor the human agent's cursor movements, peripheral activity, or physiological signals from devices to determine if the human is actively engaged in the task or has entered a temporary wait-state. The system may also look for visual and audio cues, such as via camera and microphone devices, such as to detect the human agent's facial expressions, tone, brain activity, to determine if a determination can be made if the human agent is still thinking or doing an activity that may be associated with thus human agent still in process of working on the task.

At block 230, in some embodiments, AI agent response generation may occur simultaneously with the human agent's activity or may occur within a predetermined threshold period of time window from the human agent's activity or start of the human agent's response. The AI agent may utilize an LLM, or similar algorithmic engine, to produce an independent response. In one embodiment, this AI agent's generation process may be hidden from the human agent at block 220 to prevent influence or bias, ensuring that the machine intelligence provides an objective, independent alternative for the subsequent evaluation stage.

At block 240, in some embodiments, a hardware-managed buffering period may be introduced. This temporal delay, which may range from 500 ms to 2 seconds, or another dynamically determined interval, may be used to synchronize the disparate latencies between human and AI agent (e.g., machine processing cycles). In one embodiment, the buffer may be configured to be minimal to remain imperceptible to the end user while providing sufficient time for the independent AI orchestrator to receive both inputs. In another embodiment, the system may employ a typing visualization, or a clock or buffering visualization, or some other time of processing visualization, on the user interface to mask this background processing, giving the appearance of real-time generation while the backend evaluation is finalized.

At block 250, in some embodiments, the evaluation module may perform a scoring, such as in real-time, of the generated responses during the buffering period. The module may score the human agent response and the AI agent response against several criteria, such as an empathy score, company compliance, compassion, or user comprehension proficiency. In one embodiment, the module may apply a dynamically shifting threshold, which may be determined by the nature of the query or the user's role, to determine if a response meets the required quality level. For example, a query regarding critical financial data might require a high accuracy score, whereas a routine IT task may utilize a lower threshold.

At block 255, in some embodiments, the system may detect that the designated time for the buffering period has expired. This trigger may indicate that the evaluation cycle must conclude to ensure a timely delivery to the user interface. In one embodiment, if the human agent has not completed their task before time expires, or has not shown an indication that the human agent is still working on the task, the system may utilize aforementioned interruption detection, such as monitored cursor patterns or physiological sensor data, to determine whether to extend the buffer or proceed with the AI response alone to prevent storage waste or bandwidth delays. In another embodiment, if it seems as that the human agent has paused, or a determination is made that the human agent is still working on the task, such as a certain delay has passed, then the system may evaluate using the interruption detection to determine whether it's just a pause or whether the human agent has finished the task. If a determination is made that a human agent has finished the task, then the human agent's response may be identified for potential selection, along with the AI agent's response. As will be described below, that would include determining which segment of the human agent and AI agent responses to select for the final response, including a hybrid selection or a selection between one response or another in their totality.

At block 260, in some embodiments, the responses may be identified as being ready for selection. Based on the scores determined in the evaluation module 250, the system may select the human response, the AI response, or a hybrid combination of both. In one embodiment, if the human response exceeds the quality threshold, it may be prioritized even if the AI score is technically higher, specifically to preserve personalization or empathy. In some embodiments, such a selection may be made only for segments that involve personalization or empathy.

In one example, a user may submit a high-priority enterprise query regarding quarterly profit numbers (at block 210). A human vice president may begin drafting a response (at block 220) while the system concurrently triggers an enterprise-trained AI agent to generate its own version (at block 230). The system may manage a 1-second buffer (at block 240) while the evaluation module 250 analyzed both for compliance and factual accuracy. As the VP pauses briefly to consult a secondary internal record, hardware-integrated sensors (at block 220) may confirm the agent, i.e., the VP, is still engaged, preventing the system from prematurely expiring the time (at block 255). Upon synchronization, the AI orchestrator may determine whether both agents have met the high accuracy threshold for this stakes-task, and the responses may be presented for selection (at block 260) to be packaged for the end user.

In another embodiment, the system may provide a PiP simulation window during the response generation process. This may allow the human agent at block 220 to request a background simulation of what the AI would do next in the workflow, including simulated cursor movements, without actually executing the changes until the human agent accepts the guidance.

In yet another embodiment, the generation of responses may be gamified as a head-to-head challenge between the human and AI agents. Even if one agent wins the challenge overall, the system may still identify a specific segment or preliminary workflow step that was handled better by the losing agent and incorporate that superior segment into the final response ready for selection at block 260. In some embodiments, such a challenge may be provided to both human and AI agent prior to them working on the actual query, and their challenge results may be used to assign the query, or different segments of the query to them, and/or their results of the query may be selected on a segment by segment basis based on how they performed in the challenge which had segments that shared characteristics of the segments in the query.

For example, a challenge may have a financial segment and a policy segment. In this challenge example, the human agent may have performed better in the policy segment than the AI agent. Based on the results of the challenge, in one embodiment, the portion of the query relating to the policy segment may be given to the human agent since they performed better than the AI agent in the segment of the challenge which shared the characteristics with the policy segment. In another embodiment, the entire query may still be simultaneously given to both human and AI agent, however, the response to the query's policy segment may be weighted more in favor of the human agent, since the human agent performed better in the corresponding challenge segment, and the response of the human agent may be selected for the policy segment of the query response in the final selection.

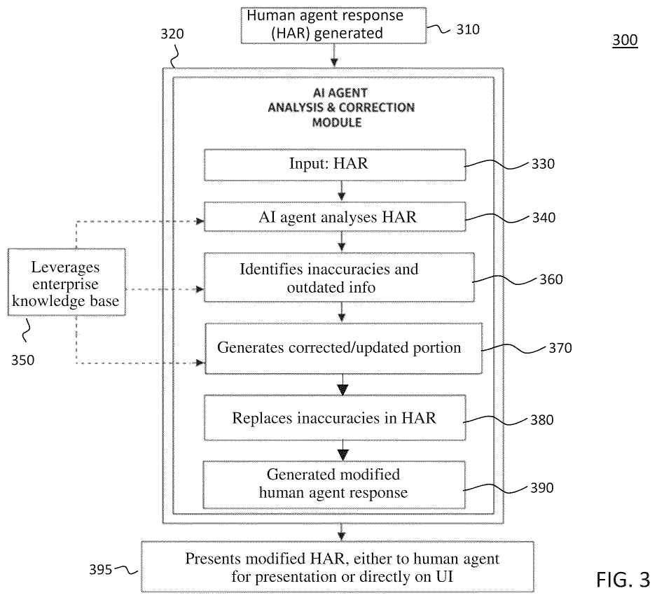

FIG. 3 is a flowchart of an example of a process 300 for identifying inaccuracies in a human agent response and automatically correcting the inaccuracies to generate a modified response, in accordance with some embodiments of the disclosure. Process 300 may be implemented, in whole or in part, by computing devices and hardware architecture such as those depicted in FIG. 11 and FIG. 12.

In some embodiments, process 300 may serve as an AI-driven quality assurance layer that evaluates, such as in real-time, human-generated content against an enterprise knowledge base to ensure technical accuracy and currency without necessarily discarding the human agent's empathetic or personalized tone. Process 300 may facilitate a transition from raw human input to a technically validated final output through a series of analytical and generative steps managed by an AI Analysis and Correction Module.

At block 310, in some embodiments, a human agent response (HAR) may be generated in response to a user query. This stage may involve the human agent utilizing their interface to draft a proposed solution or answer. In one embodiment, this HAR may be complete, or it may be a partial workflow step submitted for validation. For example, a human agent might draft a response explaining how to update a specific software suite, but they may inadvertently reference an outdated version number or a decommissioned server link.

At block 320, in some embodiments, the AI Agent Analysis & Correction Module may receive the input HAR 330. This module may act as the central logic hub for the technical refinement of the agent's input. In one embodiment, the module may be triggered automatically upon the detection of a task completion signal from the human agent interface, or it may operate as a background process that monitors the HAR while it is still being drafted. It may also incorporate the features of the buffering period and the process described in FIG. 2 At block 340, in some embodiments, the AI agent may analyze the HAR to decompose the response into its constituent technical claims, or into separate segments. This analysis may involve parsing the text into semantic segments to isolate factual assertions from empathetic or stylistic elements. In one embodiment, the AI agent may evaluate the logical flow and coherence of the HAR to ensure that the human agent's narrative remains intact even if specific technical data points require modification.

At block 350, in some embodiments, the AI agent may leverage an enterprise knowledge base to perform a comparative validation of the HAR. The enterprise knowledge base may include up to date, such as up-to-the-minute or real-time documentation, product specifications, or internal policy updates that are more current than the human agent's individual training. For example, if the human agent asserts that a service is available 24/7, the AI agent may check the knowledge base to see if a specific maintenance window has been scheduled for the user's region that would invalidate that claim.

At block 360, in some embodiments, the AI agent may identify inaccuracies and outdated information within the HAR. This identification may be performed on a segment-by-segment or workflow-step basis, or even more granular within a workflow step. In one embodiment, the system may flag information that is technically correct but non-compliant with current company compassion or empathy guidelines. For example, if a human agent provides a technically accurate but blunt rejection of a user's request, the AI may identify this as a soft inaccuracy based on the lack of an empathetic tone.

At block 370, in some embodiments, the AI agent may generate a corrected or updated portion of the response. This generated portion may be specifically designed to fit the context and tone of the original HAR to maintain a unified voice. In one embodiment, the system may generate multiple candidate corrections and select the one that has the highest coherence score when integrated with the human agent's surrounding text.

At block 380, in some embodiments, the system may replace the identified inaccuracies in the HAR with the AI-generated corrected or updated portions. This replacement may be handled in a way ensuring that only the specific factual errors are removed while preserving the human agent's unique expertise. In one embodiment, the system may use back spacing and rewriting visual effects on the user interface to simulate a natural correction process, masking the underlying AI intervention.

At block 390, in some embodiments, a modified human agent response may be generated as the final output. This final version may represent a hybrid of human empathy and AI-verified technical precision. In one embodiment, the system may assign weights to the human and AI portions, where the human agent's seasoned expertise (e.g., if they are a senior manager) may allow for more stylistic flexibility, while the AI's portions may be strictly enforced for factual accuracy.

At block 395, in some embodiments, the system may present the modified HAR, either to the human agent for presentation or directly on the user interface (UI). If presented to the human agent, the AI agent may provide personalized feedback explaining the specific reason for the correction and providing links to the knowledge base for the agent's future learning. If presented directly on the UI, the response may be color-coded or highlighted or visually distinguished in another manner to show the end user which portions were human-authored, and which were AI-corrected.

In one example of using process 300, a user may query about a refund policy for a high-priority account. A human agent may generate a response (block 310) stating that a refund will be issued in 10 business days. The AI Module (block 320) may analyze the HAR (block 340) and check the knowledge base (block 350), which may reveal that for this specific high-priority account tier, the policy was updated yesterday to 3 business days. The AI may identify the 10 days as an inaccuracy (block 360), generate the corrected 3 days portion (block 370), and replace the text in the response (block 380). The final modified response (block 390) may then be presented to the user (block 395) with the empathetic tone of the human agent but the accurate, updated data provided by the AI.

In another embodiment, the AI agent may act as a live guidance system by providing a PiP simulation for the human agent. While the human is drafting the HAR, the AI may show a simulated execution of a corrected workflow in a separate window, allowing the human agent to accept or reject the AI's technical corrections in real-time before the final response is packaged. In yet another embodiment, the modified HAR may be subjected to a head-to-head gamified challenge and based on the results, assignments or portions of the results may be selected, as described in FIG. 2.

FIG. 4 is a flowchart of an example of a process 400 for task completion and interruption detection, utilizing various hardware components to determine the active state of a human agent, in accordance with some embodiments of the disclosure. Process 400 may be implemented, in whole or in part, by computing devices and hardware architecture such as those depicted in FIG. 11 and FIG. 12.

In some embodiments, process 400 may establish a hardware-rooted technical framework for monitoring human agent engagement during parallel query processing. By integrating physical sensor data and system-level analytics, process 400 may allow an unbiased AI orchestrator to differentiate between a temporary cognitive pause, or wait-state, and actual task completion or abandonment, thereby optimizing the synchronization of human and machine response streams.

At block 402, in some embodiments, a live query may be received by the electronic platform. As described in the high-level architecture of FIG. 1, this reception may trigger a parallel execution thread at block 404, wherein both a human agent and an AI agent may begin processing the query simultaneously, or within a predetermined time threshold. This concurrent workflow may serve as the baseline for evaluating which agent, or segmented combination thereof, may ultimately provide the most optimal response to the end user.

At block 406, in some embodiments, the human agent may begin generating a human agent response. Concurrently, or within a predetermined time threshold, at block 408, the machine-based AI agent may generate its own AI agent response. While these generation processes occur, the system may initiate a background monitoring thread at block 410 to track human agent activity. This tracking may not be limited to software-level inputs but may be deeply integrated with the hardware environment 412 of the human agent's workstation, with other devices associated with the human agent, such as a smartwatch, smart phone, smart glasses, heartbeat monitor, or other devices that can monitor the human agent's activity, such as smart home systems and cameras.

The hardware environment 412, in some embodiments, may incorporate a variety of physical sensors 414 and system-level monitoring tools. These sensors 414 may include laptop cameras for gaze tracking and eye-tracking, mouse movement sensors, and other workstation or non-workstation peripherals. In some embodiments, the hardware monitoring may extend to external devices 416, such as a smartphone in the agent's pocket, or wearable devices like a smartwatch or Fitbit. These devices may provide physiological statistics, including heart rate, sweat gland activity, facial expressions, and even brain activity signals, to indicate if a person may be in a thinking or pause mode. Simultaneously, or within a predetermined time threshold, system monitoring 418 and system analytics 420 may track CPU usage, RAM utilization, memory analysis, and application focus. For example, a spike in memory usage associated with a secondary research application may indicate the agent may still be actively working on the query despite a lack of keyboard input.

At block 422, in some embodiments, the system may perform a logic check to determine if human agent activity is detected based on the aggregate data from the hardware environment 412. If no physical or system activity is detected, the system may enter a wait-state active mode 424. If activity is detected, the system may proceed to analyze the nature of that activity through a temporal and contextual lens.

At block 426, in some embodiments, the system may utilize an analyzing timer to evaluate the duration of any pauses or active segments. This timer may be compared against historical query data and complexity metrics at block 428 to establish a dynamic context. For example, the system may analyze historical analytics to determine that for a query of a certain complexity, this particular agent may typically pause for a maximum of two to three minutes before rejoining the task. If such a baseline is established based on historical patterns, then a pause that exceeds the historical pattern for a query or segment of the query of similar complexity may be determined as a) the human agent has completed the task or b) the human agent is no longer processing the task. Comparisons of the pause with historical patterns for the same level of complexity may be made for the query, each segment of the response, or the response in its totality.

At block 430, in some embodiments, a determination may be made as to whether the detected activity, or lack thereof, is within a predetermined threshold time. If the pause exceeds this threshold, the system may conclude that the human agent may have finished or abandoned the task. However, if the agent returns within the interval, the system may ensure their complete performance is captured rather than just an interim step.

At block 432, in some embodiments, the system may perform a contextual check to determine if the detected activity is related to the specific live query 402. If the hardware sensors 414 and system analytics 420 indicate that the agent's focus may have shifted to an unrelated task or application, the system may decide not to take the human's input into account for the current parallel processing cycle.

At block 434, in some embodiments, if the activity is deemed query-related and within the threshold time, the system may supplement or modify the human agent response. This may allow the unbiased AI orchestrator to incorporate the additional time the human agent may have spent improvising or changing the task. The resulting data may be packaged as a complete performance of the human agent for a final comparison against the AI agent response 408.

At block 436, in some embodiments, the system may arrive at a human agent response completion detection point. This may be the technical state where the system may determine that the human agent is truly done, rather than just pausing. Once completion is detected, the processed human input may be passed to the AI orchestrator at block 438.

At block 438, in some embodiments, the unbiased AI orchestrator may perform the final evaluation and presentation to the user. By utilizing the hardware-specific details from the task completion detection 436, the orchestrator may ensure it is judging the human's best and most complete response against the machine-generated alternative.

In one example of use of process 400, a human agent may receive a complex quarterly profit query (block 402). The human agent may begin drafting a response (block 406) but then may stop typing for 90 seconds. While the unbiased AI agent might initially assume the task is finished (block 436), the workstation's camera gaze tracking (block 414) and the human agent's Fitbit heart rate data (block 416) may indicate the agent may be in a deep-thinking mode related to the query (block 432). Simultaneously, system analytics (block 420) may show the agent may be actively scrolling through an internal profit database. Because this activity may be within the historical threshold for complex tasks (block 430), the analyzing timer (block 426) may allow the human agent to rejoin and complete their response (block 434). This total performance may then be evaluated by the orchestrator (block 438) for final delivery to the user.

In another embodiment, the system may initiate a PiP simulation for the human agent during the generation phase. While the human may be in a thinking pause detected by hardware sensors 414, the AI may present a simulation of the next workflow steps in a background window, allowing the human to observe simulated cursor movements and accept or reject that guidance as part of their complete performance.

In yet another embodiment, the response generation may be treated as a head-to-head challenge between the human and AI agents and based on the results of the challenge, which may occur prior to the query assignment, or prior to accepting the query results from the agent, assignments or portions of the results may be selected, as described in FIG. 2.The hardware monitoring 412 may ensure that even in a gamified environment, the system may accurately track the segment-by-segment performance of each agent to determine which specific preliminary challenge steps may be included in the final user response.

FIG. 5 is an exemplary illustration 500 of a human agent 510 being monitored by integrated hardware to evaluate the active state of the human agent and/or generate tokenized data, in accordance with some embodiments of the disclosure. In some embodiments, this figure may depict the physical layer of the system where biological and environmental signals may be captured by various sensors to provide a hardware-rooted determination of the agent's task status, cognitive load, and emotional state. By intertwining physical biometric monitoring with software-level analysis, the system may create a technical framework for precise response synchronization and data provenance.

In one embodiment, the human agent 510 may be depicted working at a workstation comprising a computing device 520, such as a laptop. The computing device 520 may be configured with internal and external sensors to monitor the agent's physical interaction with the system. For example, a laptop camera 530 may be utilized for eye-tracking and gaze monitoring. In some embodiments, the software may analyze the camera 530 data to detect hesitation or frustration on the facial expressions of the agent 510, which may indicate a lack of confidence in the current response approach. This visual data may provide a critical hardware signal that the human agent may be in a state of cognitive struggle rather than simply being idle.

In some embodiments, the human agent 510 may wear or carry secondary peripheral devices, such as a smartwatch or Fitbit 540 and a smartphone 550. These devices may serve as specialized hardware sensors that may capture physiological statistics. For instance, the smartwatch 540 may monitor heart rate and skin sensors (e.g., sweat gland activity), while the smartphone 550 may provide additional sensors for motion or brain activity detection. If the heart rate is high during a specific segment of a call or query response, the system may determine that the agent 510 may be agitated, potentially impacting the quality of their response. In addition, any such activity, or physiological statistics, that may be associated with thinking, pausing, contemplating, or in the midst of the task, may also be used to identify that the human agent is either still working on the task, such as a segment of the response, or has completed it.

At block 560, a Hardware Sensor Integration Module may act as the central hub for ingesting disparate signals from the camera 530, the wearable 540, and the mobile device 550. This module may perform a hardware-level fusion of the data, combining visual gaze patterns with biometric stats to determine the agent's true work state. In one embodiment, this module may optimize system memory by only re-initiating evaluation protocols when the hardware signals may indicate the agent is transitioning from a thinking pause back to an active doing phase.

At block 570, the system may generate tokenized data (Token Generation Data) based on the combined sensor signals. These tokens may act as hierarchical virtual signatures that may authenticate the agent's identity and tie the generated response to a specific set of hardware-verified biological states. This technical logic may ensure that every segment of a response may be attributed to an agent based on their actual physical performance and engagement level at the time of creation.

An example of the process in FIG. 5 may involve a human agent 510 addressing a high-complexity query on their laptop 520. While the agent 510 may pause their typing to consider a difficult workflow step, the laptop camera 530 may detect a steady gaze directed at the screen (block 530), and the smartwatch 540 may report a heart rate indicative of focused concentration (block 540). The Hardware Sensor Integration Module 560 may analyze these signals and determine that the agent may be in a pause/thinking mode rather than having abandoned the task. Once the agent 510 may resume keyboard interaction, the system may generate a token 570 that may verify the response segment was created by a focused human agent. This hardware-verified state may then be used by the unbiased AI orchestrator to score the human's complete performance against the parallel AI agent.

In another embodiment, the system may utilize the camera 530 and sensor 540 to establish a baseline for each specific agent. For example, the system may determine through historical hardware analytics that a specific agent may typically pause for a maximum of three minutes when addressing quarterly profit queries. If the hardware signals during a live query may deviate significantly from this baseline, such as detecting a wandering gaze or an abnormally high heart rate, the system may trigger a PiP simulation to guide the agent through the next steps, automatically providing live assistance based on the detected hardware-level distress. The pause detection mechanism may also be applied in the head-to-head challenge described in various embodiments herein.

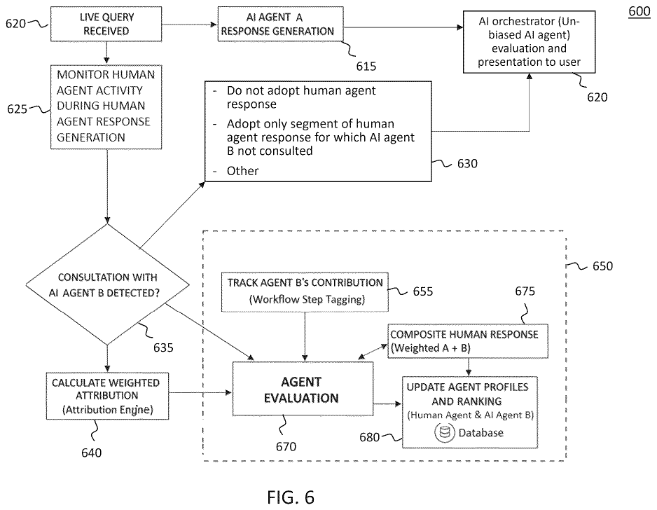

FIG. 6 is a flowchart of an example of a process 600 for detecting inter-human agent consultation and applying weighted attribution to individual agent profiles, in accordance with some embodiments of the disclosure. Process 600 may be implemented, in whole or in part, by computing devices and hardware architecture such as those depicted in FIG. 11 and FIG. 12.

In some embodiments, process 600 may establish a logic framework for accurately distributing credit and performance rankings in collaborative environments. By monitoring human agent interactions and identifying third-party or supervisory consultations, the system may ensure a fairness ranking that distinguishes between an agent's solo expertise and contributions derived from external human or AI assistance.

At block 620, in some embodiments, a live query may be received by the electronic platform. As described in previous embodiments, this may trigger parallel response generation, where an AI Agent A Response Generation module 615 may begin processing the query simultaneously, or within a predetermined time threshold, with the assigned human agent. This dual-stream approach may ensure that even if a human agent enters a complex consultation phase, a baseline response may be prepared for the unbiased AI orchestrator 620.

At block 625, in some embodiments, the system may perform a continuous monitoring of human agent activity during the response generation phase. This monitoring may utilize the hardware-integrated sensors and system analytics detailed in FIG. 5 to detect patterns of interaction that may suggest the primary human agent (Agent A) has reached out to a secondary agent (Agent B) or a supervisor for expert guidance. For example, the system may detect a screen-sharing session or the opening of a collaborative chat window as indicators of consultation.

At block 635, in some embodiments, the system may execute a logic check to determine if a consultation with an AI Agent B or a secondary human Agent B is detected. If no consultation is detected, the system may proceed with standard evaluation. However, if a collaborative interaction is identified, the system may tag the specific workflow steps or response segments associated with that interaction to ensure accurate attribution.

At block 640, in some embodiments, a weighted attribution calculation may be performed by an attribution engine. This engine may determine the relative weight to place on each agent's contribution based on the duration of the consultation and the complexity of the workflow step involved. In one embodiment, the unbiased AI agent may determine that the portion consulted represents only a small percentage of the total response, and thus may apply a weighted score that reflects the primary agent's majority contribution while still crediting the consulting agent for their specific input.

At block 630, in some embodiments, the system may apply adoption logic based on the detected consultation. The system may choose not to adopt the human agent's response segment if the consultation level exceeds a specific threshold, or it may adopt only the specific segments of the human agent response for which a secondary agent was not consulted. This may ensure that the final response presented by the AI orchestrator 620 is derived from the most qualified and authenticated source.

At block 650, in some embodiments, a comprehensive agent evaluation and ranking stage may be initiated. This stage may involve several sub-processes, starting with block 655, where the system may track Agent B's specific contribution through workflow step tagging. By assigning metadata tags to specific phrases or technical solutions, the system may create a granular map of who authored which portion of the collaborative response.

At block 670, in some embodiments, an agent evaluation may be performed based on the tagged contributions. This evaluation may consider the performance of both the original agent and the consulting agent against the dynamic quality threshold. At block 675, a composite human response may be generated using a weighted blend of Agent A and Agent B's inputs (e.g., Weighted A+B). This composite may represent the most technically accurate human-driven solution possible through collaboration.

At block 680, in some embodiments, the system may update agent profiles and rankings within a centralized database. This fairness ranking logic may ensure that the original human agent does not receive unearned credit for a step they were unable to perform solo. Instead, consulting Agent B's profile may be updated to reflect their expert guidance, while Agent A's profile may be updated to reflect their coordination and the successful segments they authored independently.

An example of use of process 600 includes a primary agent, such as Agent A, responding to a query regarding a specialized legal clause, at block 620. During generation, Agent A may open an internal consultation window to ask a senior manager (Agent B) for guidance on the specific phrasing, at block 625. The consultation may be detected, at block 635, and the attribution engine 640 may determine that the manager provided 20% of the technical input. The system may tag the manager's segment, at block 655, and evaluate both contributions, at block 670. While the final response delivered to the user may be a composite, at block 675, the manager's profile may be ranked higher for legal expertise, at block 680, and Agent A may be rewarded for identifying the need for a more accurate consult rather than providing an inaccurate solo guess.

In another embodiment, the system may provide the human agent with a PiP simulation window during the consultation phase. This may allow Agent A to request a background simulation of what a supervisor or an AI agent would suggest for the next workflow step, including simulated cursor movements, allowing Agent A to observe the logic before officially accepting it into the collaborative response ready for evaluation at block 670.

In yet another embodiment, the collaborative generation of the composite response 675 may be gamified as a head-to-head challenge between the human team and the parallel AI agent. The system may evaluate the collaborative human effort against the AI's solo response on a segment-by-segment basis, ensuring that even if the AI wins the overall challenge, a specific expert segment authored by the consulting manager (Agent B) may be identified and prioritized for the final user display. In yet another embodiment, the response generation may be treated as a head-to-head challenge between the human and AI agents and based on the results of the challenge, which may occur prior to the query assignment, or prior to accepting the query results from the agent, assignments or portions of the results may be selected, as described in FIG. 2.

In another embodiment, the system may further differentiate between purely human-driven responses and those assisted by external machine intelligence. Process 600 may evaluate whether the human agent independently utilizes their own expertise and enterprise-specific tools to develop a workflow on a segment-by-segment basis. In some instances, an enterprise may prefer a true comparison between the human agent's cognizance and the configured AI agent, and as such, the human agent's use of an outside AI platform or internal chatbot may not be considered a valid representation of human expertise. If the monitoring logic detects that a human agent has reached out to an external AI source, such as a large language model, or an unauthorized internal AI agent, the weighted attribution calculation at block 640 may down-weight the human's contribution. This down-weighting may negatively impact the agent's fairness ranking because the system may prioritize original human thinking over AI-assisted drafting. To discourage such behavior, some embodiments may trigger a real-time alert on the human agent's interface indicating a preference for independent determination. In yet other embodiments, the system may automatically alert a supervisor or manager if the human agent attempts to utilize an unauthorized AI tool during the response generation phase.

In another embodiment, the system may provide a hardware-isolated sandbox simulation environment to facilitate real-time workflow verification without compromising the human-only response requirement. Within this sandbox, a PiP simulation window may be rendered on the user interface, providing the human agent with a non-persistent background execution of what the AI would do next in a workflow. This simulation may include high-fidelity visual cues, such as simulated cursor movements and automated field entries, allowing the human agent to observe the AI's intended logic without actually committing changes to the live query.

Furthermore, this sandbox simulation may incorporate a predictive what-if logic engine that may allow the human agent to manipulate specific parameters within the PiP window to observe potential outcome variances. For example, the agent may adjust a variable and the simulation may immediately render the corresponding AI-generated response and logical downstream effects. By providing this low-risk, hardware-segmented environment, the system may optimize memory and processing resources by allowing for exhaustive technical validation before any data is officially transmitted to the end user. This collaborative pre-verification stage may allow the human agent to explicitly guide the AI to take steps five and seven of a proposed sequence, observing the simulated execution before providing final authorization for the overall workflow to proceed.

FIG. 7 is a flowchart of an example of a process 700 for shifting evaluation criteria and performing dynamic threshold selection based on query nature, task importance, and user role, in accordance with some embodiments of the disclosure. Process 700 may be implemented, in whole or in part, by computing devices and hardware architecture such as those depicted in FIG. 11 and FIG. 12.

In some embodiments, process 700 may establish a non-static, intelligence-driven framework for determining the rigor of the evaluation metrics applied to agent responses. By analyzing the contextual risk and the organizational status of the parties involved, the system may dynamically balance the trade-off between technical accuracy and operational speed or cost, which may ensure that high-stakes queries are subjected to appropriately stringent validation.

At block 710, in some embodiments, a live query may be received by the electronic platform. This reception may initiate the evaluation workflow by providing the raw input that may be scrutinized to determine its technical and enterprise significance. For example, a query may be ingested from a customer support portal, trouble ticket, or an internal executive communications channel.

At block 715, in some embodiments, the system may analyze the received query to determine various query characteristics. This metadata extraction may serve as the primary input for the downstream threshold calculation logic. In one embodiment, the system may use natural language understanding (NLU) or one or more LLMs to identify the specific domain of the request, such as IT support, financial reporting, or human resources.

At block 720, in some embodiments, the nature of the query may be assessed, which may categorize the request as simple, complex, or highly technical. This assessment may directly influence how much precision may be needed. For instance, if a query is identified as a simple IT task, such as, how to clear a browser cache, the system may prioritize a fast, straightforward response over an exhaustive technical audit. On the other hand, a highly complex technical query regarding infrastructure migration may trigger a more rigorous evaluation protocol. Rules may be configured, including automatically by an LLM, on what a specific type of query should be characterized as, e.g. complex, simple, or varying degrees in between.

At block 725, in some embodiments, the system may determine the importance of a task by evaluating the potential impact of the query on the enterprise. Rules may also be generated on what type of impact the response to the query may have on the enterprise. In some embodiments, a tool may pop-up on the interface to show potential impacts to the enterprise. This logic may distinguish between routine operational requests and high-risk strategic tasks. For example, a query regarding the reporting of quarterly profits may be identified as having high enterprise impact because an inaccurate response may lead to regulatory violations or significant financial damage. In such cases, the system may allocate more computational resources to ensure the evaluation is as stringent as possible.

At block 730, in some embodiments, the system may identify the user title or role of the individual who submitted the query. This factor acknowledges that the quality of an answer often may depend on the seniority of the recipient. In one embodiment, the system may set a higher quality threshold for a query submitted by a CEO or Vice President compared to a query submitted by a general staff member, which may ensure that executive communications are technically flawless.

At block 735, in some embodiments, a dynamic threshold calculation module may ingest the inputs from the nature of the query, task importance, and user role to establish a specific evaluation standard. This module may be configured to balance accuracy versus cost, as not every query may justify the expense of high-level AI scrutiny. In one embodiment, the module may shift the threshold based on these input factors to ensure the resulting evaluation may be contextual and efficient.

At block 740, in some embodiments, an AI Agent evaluation threshold may be established as the target metric for incoming responses. This threshold may serve as the benchmark against which the AI Agent responses 745 may be measured. In one embodiment, this threshold may be represented as a percentage score, such as 95% for critical tasks or 70% for routine tasks, or some other configured percentage.

At block 750, in some embodiments, a score comparator may perform a final comparison between the agent's actual performance score and the dynamic threshold established at block 740. If the agent's score meets or exceeds the threshold, the response may be adopted; if not, the system may trigger further refinement or correction. A weighting technique may also be used to weigh segments of the response and set segment-by-segment thresholds.

An example of using process 700 may be where an internal user may ask for the company's current debt-to-equity ratio, at block 710. The system may determine the query characteristics, at block 715, and may identify it as a highly technical financial request, at block 720. Because inaccurate financial data may damage the enterprise, it may be flagged as a high-importance task, at block 725, and since the user may be the Chief Financial Officer, at block 730, the threshold calculation module, at block 735, may set an exceptionally high evaluation threshold of 98% at block 740. The resulting agent response, at block 745, may then be compared against this 98% benchmark, at block 750, to ensure the CFO receives only the most accurate data possible.

In another embodiment, the dynamic threshold selection may be influenced by the title and expertise of the responding human agent. For example, if a seasoned executive like a CEO or Vice President may be providing the response, the system may factor in their seniority and may weigh their input more heavily, even if the raw technical score may be slightly lower than a standard AI output. Seniority ranking may be configured into the system or the LLM model to use such ranking and hierarchy in the dynamic threshold selection.

In yet another embodiment, the system may utilize a second, independent AI agent to manage the scoring comparison at block 750. This independent agent may remain blind to the source of the response, whether human or AI, to ensure the comparison against the dynamic threshold may be performed without any inherent bias toward machine-generated or human-generated content.

FIG. 8 is a block diagram of an exemplary user interface system 800 illustrating the visual differentiation of response segments and the provision of an interactive toggle for segment-by-segment response adoption, in accordance with some embodiments of the disclosure. In some embodiments, the system 800 may provide the technical infrastructure to present a hybrid or multi-source response to an end user while maintaining transparency regarding the provenance of each data segment. By providing interactive elements, the system may allow the user to dynamically refine the final output by selecting alternative inputs from a pool of available human or AI agent responses.

At block 810, in some embodiments, a combined response adoption engine may determine how to package the disparate response segments into a single, cohesive unit. This engine may apply logic to ensure that when a response may be comprised of both human and AI inputs, the transitions between segments are logically sound and the overall narrative flows properly. In one embodiment, this engine may identify which segments have met or exceeded the dynamic quality threshold and may automatically prioritize them for the initial presentation.

At block 815, in some embodiments, a final response may be generated, typically comprising a plurality of segments (e.g., Segment 1, Segment 2, and Segment 3). Each segment may represent a distinct portion of the answer, such as a greeting, a technical solution, or a closing statement. For example, a final response 815 might contain three segments where the first and third may be authored by a human agent, while the middle segment may be provided by an AI agent to ensure factual accuracy.

At block 820, in some embodiments, a user interface (UI) may be provided to render the final response. The UI may act as the presentation layer for the electronic platform 120 and may include specific hardware-driven interaction zones for the user. Within this interface, Segment 1 (AI agent) 825, Segment 2 (Human agent) 830, and Segment 3 (Human agent) 835 may be displayed as a unified message. To maintain clarity, the system may initially hide the multi-agent nature of the response or, in other embodiments, may immediately apply visual markers to distinguish the sources.

At block 840, in some embodiments, the system may visually distinguish segments based on the source of the response, such as human or AI agents. This differentiation may be implemented through a variety of technical methods, including color-coding (e.g., blue for AI, green for human), highlighting, bolding, utilizing different font styles, or other visually distinguishing features. In one embodiment, a legend may be provided within the UI 820 to allow the end user to quickly decode which processing cycle may have been responsible for which part of the text.

At block 845, in some embodiments, the system may provide an interactive toggle for each segment. This toggle may allow the user to switch the currently displayed segment to an alternative version generated by a different agent. For example, if the user may be dissatisfied with Segment 2 (Human agent) 830, they can use the toggle to switch to the parallel version generated by the AI agent during the initial processing phase. In another embodiment, the toggle may allow the user to revert an AI-corrected segment back to the human agent's original raw input.

At block 850, in some embodiments, the interactive elements may be triggered by user actions such as a hover or a click. When a user may move their mouse over a specific segment, a pull-down menu or a toggle icon may appear underneath or adjacent to the text.

For example, tapping on a highlighted segment on a touch-sensitive display may reveal a menu of alternative inputs from other agents or supervisors. In another embodiment, when a user may move their mouse over a specific segment, both human and AI agent responses may be displayed one above each other, or within a predetermined proximity, without one response overlaying and hiding the other, such that both responses are displayed for selection. The user's selection may also be logged for future pattern detection. In another example, the user may move their mouse over a specific segment, the second option of the response, such as an AI response if the human response is displayed, may be displayed as a 3D image. Statistics may also be displayed on what other employees in the enterprise select for their response, e.g., for segment 3, 43% selected human response and 57% selected AI response, for related queries or related responses.

At block 860, in some embodiments, the system may perform the technical switch of the clicked or toggled segment to another agent. This process may happen in real-time, replacing the text in the DOM of the UI 820 without requiring a full-page refresh. For instance, if a user may switch Segment 2 to the AI agent response, the system may retrieve the machine-generated text from the backend evaluation module 250 and may update the display accordingly.

One example of the process of FIG. 8 includes an end user receiving a three-segment response regarding a complex insurance claim. Segment 1 (AI) provides the policy numbers, Segment 2 (Human) explains the claim denial, and Segment 3 (Human) provides the next steps. The user may hover over Segment 2, at block 850, which may be highlighted in green to indicate its human origin, at block 840. The user may click the interactive toggle, at block 845, to see what the AI agent may have suggested for that denial explanation. The system may switch Segment 2 to the AI's more technical, rule-based version, at block 860. If the user may accept this new version, the system may record this as a preference for the AI agent for that specific segment type, subsequently updating the ranking and learning database 155.

In another embodiment, the interactive toggle 845 may provide a third option beyond the original human and AI agents. For example, a human agent may designate a supervisor or manager to provide expert guidance on a particularly sensitive segment. The pull-down menu 850 may then allow the end user to switch that segment to the manager's expert answer.

In yet another embodiment, if a third toggle option does not exist, the user interface 820 may provide an option within the pull-down menu to request expert advice. Upon selection, the system may automatically transmit an email or text alert to a physical device of a human expert in the user's circle. The expert's subsequent answer may then be evaluated in context and presented as a new toggle choice within the original response thread.

In some embodiments, the system may utilize the results of these toggling actions for head-to-head gamified challenges. If a user may consistently toggle away from a specific agent's segments in favor of another's, the system may utilize this hardware-level interaction data to decrease the rank of the first agent while increasing the rank and training weighting of the second agent. In yet another embodiment, the system may utilize the results of these toggling based on the results of the challenge, which may occur prior to the query assignment, or prior to accepting the query results from the agent, assignments or portions of the results may be selected, as described in FIG. 2.

FIG. 9 is a diagram illustrating the combination logic engine 950 used for merging segmented portions of an original human agent response and an original AI agent response into a final combined response, in accordance with some embodiments of the disclosure. For example, the original human agent response 910, an original AI agent response 930, into a final combined response 960.

In some embodiments, FIG. 9 may depict the structural decomposition of parallel response streams, such as from the human agent and the AI agent, into discrete segments and the subsequent algorithmic reconstruction of a hybrid output. This architecture may allow the system to prioritize specialized human expertise while leveraging machine intelligence for factual precision and technical currency across different portions of a single communication thread.

At block 910, in some embodiments, an original human agent response (HAR) may be provided by the human agent interface 115. As depicted, the system may parse this response into at least three distinct segments: a first non-key segment 915, a key segment 920, and a second non-key segment 925. Whether a segment is to be regarded as a key or non-key segment may be based on a recommendation from an LLM, or may be configured into the system, such as based on importance to the enterprise, or importance based on another configured criteria. In one embodiment, this parsing may be performed by analyzing the semantic boundaries of the text to identify specific claims, data points, or stylistic components. For example, the human agent's expertise may be concentrated in a specific source of profit analysis, which the system may identify as the core technical value of the human input.

At block 930, in some embodiments, an original AI agent response may be generated simultaneously, or within a predetermined time threshold, by the AI agent module 117. Similar to the human input, the AI response may be decomposed into corresponding segments, such as a first AI non-key segment 935, an AI key segment 940, and a second AI non-key segment 945. In one embodiment, these segments may represent the AI Agent/machine's best attempt at the same workflow steps being addressed by the human agent. For instance, segment 945 might provide an official report schedule that the AI may have derived from an up-to-the-minute enterprise knowledge base.

At block 950, in some embodiments, the combination logic engine may receive the segmented data from both the human and AI agents. This engine may act as the primary orchestrator for hybrid construction, applying rules to determine which segment from which source may be most optimal for the final output. In some embodiments, the rules may be pre-configured. In another embodiment, the rules may be dynamically configured based on the nature of the query, importance of the response of the segment to the enterprise, or another pre-configured factor. In one embodiment, the engine may apply weighting factors based on the human agent's title or expertise level to ensure that critical human insights are preserved. The engine may be further configured to apply rules ensuring that the combined response may remain coherent, may be logically blended, and may flow properly, which may prevent the delivery of disjointed or contradictory segments to the end user.

In some embodiments, the combination logic engine 950 may distinguish between key and non-key segments based on predefined criteria. As used herein, a key segment may be defined as a portion of the response determined to be critical to an enterprise based on potential financial impact, reporting requirements, or regulatory risk. In one instance, the engine may identify segment 920 as a key segment because it may attribute a new record to a specific topic or an important topic, such as the Asia launch, a nuance that may be derived from the human agent's specialized domain knowledge. On the other hand, non-key segments may include routine data points or status updates where machine precision may be prioritized.

At block 960, in some embodiments, the final combined response may be generated as a result of the combination logic engine's 950 processing. As depicted, the final response 960 may be constructed using the first non-key segment 965 from the AI agent, the key segment 970 from the human agent, and the second non-key segment 975 from the AI agent. This arrangement may ensure that the final response may contain accurate factual data (from AI agent) while retaining critical specialized insight (from human agent) that originally may have attributed the profit record to the Asia launch.

An example of using the process in FIG. 9 may involve a user asking for a financial update regarding quarterly performance. The human agent may draft a response, at block 910, stating that profits may be 1.2 billion and that a new record may have been set due to a specific Asia launch (key segment 920). Simultaneously, or within a predetermined time threshold, the AI agent module may generate a response, at block 930, that may also confirm the 1.2 billion profit but may provide a more precise release date for the official report, e.g., the non-key segment 945. The combination logic engine 950 may analyze both and may determine that the human's Asia launch insight may be a critical key segment that must be preserved. However, it may identify that the AI's phrasing for the reporting schedule may be more up to date. The final response, at block 960, then may blend the AI's precise scheduling, segment 975, with the human's expert Asia launch attribution, segment 970, to provide a high-fidelity, comprehensive answer.

In another embodiment, the system may apply a combining rule that may specify a required percentage of human versus AI content to maintain a specific tone-to-accuracy ratio. For example, a rule may be set to ensure at least 30% of a response may be human-derived when the query may be submitted by a high-ranking user like a CEO, which may ensure the response feels personalized while it may remain technically accurate.

In yet another embodiment, the final combined response 960 may be subjected to a head-to-head gamified challenge before delivery. Even if an AI agent may be determined to be the overall winner of the challenge, the system may still identify a specific preliminary segment (such as key segment 920) that the human agent may have answered better and may integrate that specific segment into the final combined response presented to the user interface. Additional options based on the results of the challenge are described in FIG. 2.

FIG. 10 is a flowchart of an example of a process 1000 for ranking an agent based on user adoption and interaction with response segments, in accordance with some embodiments of the disclosure. Process 1000 may be implemented, in whole or in part, by computing devices and hardware architecture such as those depicted in FIG. 11 and FIG. 12.

In some embodiments, the process 1000 may establish a continuous learning loop that may dynamically adjust the performance profile and authority of both human and AI agents based on real-time user feedback and behavioral data. By decomposing final responses into constituent segments and monitoring subsequent user actions, the system may provide a granular fairness ranking that may accurately reflect the utility and quality of each agent's specific contributions. In another embodiment, process 1000 may use a logic flow to rank an agent based on whether a response from the agent was adopted partially, in its entirety, or queried by segments.

At block 1010, in some embodiments, the final response may be displayed on the user display interface 160. As described in previous embodiments, this final response may be an original human agent response (HAR), an original AI agent response (AAR), or a hybrid combination thereof. In some instances, the system may visually differentiate the portions of the response that may have originated from different agents using color-coding or other graphical or visual indicators.

At block 1015, in some embodiments, the system may perform a logic check to determine if the response may have been adopted in its entirety by the end user. Adopting in its entirety may include the user accepting the answer as presented without requesting further clarification or toggling to alternative segments. In one embodiment, the system may monitor subsequent user actions, such as forwarding the response, saving it, or closing the query session, to confirm acceptance. For example, the system may monitor other user devices associated with the user for such forwarding of the response or saving it. In another example, the system may monitor the end user's texts and emails to determine such forwarding of the response or saving it. In yet another example, if the end user forwarded the response, the system may monitor any comments to the forward by others to determine whether it was accepted by the user and to whom it was forwarded. In this example, the system may look for any comments back to the end user such as, good job, this needs correction etc., to determine adoption and acceptance of the response.

If the response may be accepted as presented, the process may move to block 1020. At block 1020, in some embodiments, the system may increase the rank of the agent or agents that may have generated the response. For a hybrid response, this may include increasing the rank of both the human and AI agents in accordance with their proportional contribution. This ranking update may serve to reinforce successful response patterns within the Ranking Database (DB) 1040.

If the response may not be adopted in its entirety, the process may move to block 1025. At block 1025, in some embodiments, the system may identify the specific segment or segments from the response that may have been queried or modified by the user. This may include instances where the user may utilize the interactive toggle to switch a segment to an alternative agent's version or may ask a follow-up question specifically related to a portion of the text.

At block 1030, in some embodiments, the system may identify which agent may have generated the queried segment or segments. By cross-referencing the segment metadata with the original response logs, the system may distinguish between human-authored segments and AI-generated segments. This may allow the platform to pinpoint exactly which processing cycle or individual expertise may have failed to satisfy the user's intent.

At block 1035, in some embodiments, the system may decrease the rank of the agent that may have generated the queried segment and may increase the rank of the agent that may have generated the adopted segment. For example, if a user may toggle an AI-generated technical segment back to the human agent's original input, the system may identify that the human agent's input may have been ultimately more useful, which may result in scoring the human higher and the AI lower for that specific query type.

At block 1040, in some embodiments, the Ranking DB 1040 may store the updated performance metrics for each agent. This database may maintain historical records of agent accuracy, empathy, and compliance scores. These records may be used to automatically generate performance reports for human agents, which may provide personalized feedback on why specific portions may have been scored below a threshold. There may also be an adoption ranking on type of segments and their genre generated for the human agent. For example, a ranking that the human agent's adoption to policy related segments was 87%, empathy related segments was 74%, and finance or segments that required calculations was 61% thereby indicating that the human agent may need more training or may not be the best choice for segments related to finance or those that required calculations.

At block 1045, in some embodiments, the system may utilize the increase or decrease in rankings and the corresponding accepted response data for training or updating the responding AI model. This may create an empathy training loop where the AI agent may learn to adopt linguistic patterns or technical solutions that may have achieved high user acceptance in previous interactions.

At block 1050, in some embodiments, the system may generate an agent performance report based on the granular adoption and segment-level query data. This report may include a fairness ranking that may account for instances where an agent may have consulted a supervisor or another expert, which may ensure credit may be appropriately weighted based on actual solo performance versus collaborative input.

One example of the use of process 1000 may involve a hybrid response displayed to a user, at block 1010. The response may contain a technical segment from an AI and a policy explanation from a human. The user may hover over the AI segment and may toggle it to the human agent's alternative version, blocks 1015, 1025. The system may identify the AI as the source of the rejected segment, block 1030. Consequently, the AI's rank may be decreased while the human agent's rank for that specific technical domain may be increased, at block 1035. These updates may be committed to the Ranking DB, block 1040, and may be utilized to retrain the AI model, block 1045, to help prevent similar future rejections.

In another embodiment, the scoring and ranking in the Ranking DB 1040 may be performed by a second, independent and unbiased AI agent that may be entirely separate from the responding or evaluating agents. This may ensure that the long-term performance profiles may be maintained without any internal algorithmic bias.

In yet another embodiment, the system may utilize the accepted high-ranking segments to create head-to-head gamified challenges for agents. Even if an AI agent may be determined to be the overall winner of a challenge, the system may identify specific preliminary segments that a human agent may have answered better and may prioritize that human's answer for future similar queries based on their historical high rank for that specific segment type. Additional options based on the results of the challenge are described in FIG. 2.

FIG. 11 is a block diagram of an exemplary computing device architecture 1100 for performing the embodiments and processes discussed herein, in accordance with some embodiments of the disclosure. In some embodiments, FIG. 11 may illustrate the physical hardware layer that supports the electronic platform 120 and the various multi-agent processing modules described in FIGS. 1-10. The architecture 1100 may provide the necessary computational resources, including specialized processing, high-speed memory synchronization, and multi-modal sensor integration, that may be utilized to execute parallel human and AI agent workflows while maintaining the system-level efficiency that may be needed for real-time response generation.

In some embodiments, architecture 1100 may include a computing device 1102, which may be a server, a desktop computer, a laptop, or a distributed cloud-computing node. Computing device 1102 may act as the foundational hardware for the electronic platform 120, hosting the logic for live query reception 110 and the simultaneous generation of agent responses. By centralizing these functions within a high-performance hardware environment, the system may achieve improvements in processing efficiency, potentially reducing the latency that may be associated with serial human-to-AI handoffs.

In some embodiments, the computing device 1102 may comprise memory 1104, which may include volatile memory (such as RAM) and non-volatile storage. The memory 1104 may be configured to store instructions and routines for the AI agent module 117 and the unbiased AI orchestrator 438. In some instances, memory 1104 may facilitate the hardware-managed buffering period 240 described in FIG. 2. By leveraging high-speed memory registers to temporarily hold parallel data streams, the system may synchronize human and machine inputs without causing a perceptible delay to the end user. This technical use of memory may optimize resource allocation by ensuring that evaluation cycles may be initiated when both data streams may be successfully aligned in the hardware buffer.

In some embodiments, the computing device 1102 may include a processor 1106, which may be a central processing unit (CPU), a graphics processing unit (GPU), or specialized AI acceleration hardware. Processor 1106 may execute the logic required for the AI Analysis and Correction Module 320 and the combination logic engine 950. For example, the weighted attribution logic of FIG. 6 may be performed by processor 1106 by executing mathematical algorithms that may calculate agent contribution scores based on workflow step tagging. Furthermore, processor 1106 may improve computing efficiency by managing a state, such as an active-state, detection; it may analyze system resource spikes (e.g., CPU/RAM usage as seen in block 420) to determine if a human agent may be in a cognitive state, such as a wait-state, thereby potentially preventing the system from wasting clock cycles on premature evaluations.

In some embodiments, the computing device 1102 may incorporate a user interface 1108, which may interact with various input/output (I/O) devices 1110. These devices 1110 may include workstations where human agents may draft responses 130 and display 160 where final responses may be presented to users. The user interface 1108 may support the interactive toggle functionality 845 shown in FIG. 8, allowing for real-time DOM (Document Object Model) updates when a user may switch between human and AI segments. This hardware-software interface may ensure that visual differentiation 840 may be rendered responsively, potentially enhancing the transparency of the multi-agent system.

In some embodiments, the computing device 1102 may include data storage 1112 for maintaining the Ranking DB 1040 and the enterprise knowledge base 350. This storage layer may ensure that agent performance reports 1050 and historical query data may be preserved for model training. By utilizing efficient indexing and data retrieval strategies, the storage 1112 may allow the dynamic threshold calculation module 735 to quickly access historical query complexity factors 428, which may ensure that evaluation benchmarks may be established in real-time.

In some embodiments, other hardware 1114 may be integrated into the architecture to support specialized functions like biometric monitoring. This may include hardware interfaces for a laptop camera 530, smartwatches 540, and other sensors that may be used for interruption detection. This specialized hardware may provide a technical solution for task completion detection by feeding raw physical signals (e.g., gaze tracking or heart rate) directly into processing unit 1106 for immediate state analysis. This integration may improve system reliability by anchoring software assumptions to verified physical engagement data.

In some embodiments, a network interface 1120 may connect the computing device 1102 to one or more networks 1124. This interface may facilitate the reception of live queries 110 from remote users and the transmission of finalized responses 160. It may also support collaborative attribution engine 600 by enabling real-time communication between a primary agent, such as the human agent 510, and a consulting agent or supervisor. Through optimized packet handling, the network interface 1120 may ensure that parallel execution 404 may remain synchronized even when processing components may be distributed across multiple server nodes.

In some embodiments, the computing device 1102 may be associated with a configured medium 1122, such as a non-transitory computer-readable medium. This configured medium 1122 may store software programs and agent-evaluation logic that, when executed by processor 1106, may carry out the methods described in FIGS. 1-10. This may ensure unique logic, such as blind evaluation and head-to-head gamified challenges, which may be deployed and scaled across different hardware configurations.

An example of using the process flow utilizing FIG. 11 includes the electronic platform receiving a high-importance query, at block 110. Processor 1106 may identify the task as critical financial reporting and may utilize the network interface 1120 to trigger parallel generation threads. As the human agent works, the other hardware 1114 may monitor their facial expressions via a camera and their heart rate via a wearable sensor. Processor 1106 may ingest these signals and may determine, via memory-based analytics, that the agent may be in a state, such as a thinking pause state, rather than finished. Upon completion, the combination logic engine 950 may merge human insights with AI technical data. The final response may then be rendered via the user interface 1108, while resulting user adoption data may be stored in data storage 1112 to update the agent's rank in the ranking DB.

In another embodiment, the architecture 1100 may support a PiP simulation mode or a sandbox simulation mode. Processor 1106 may concurrently run a live workflow thread for the human agent and a background simulation thread for the AI agent. The results of the AI simulation, including simulated cursor paths, may be rendered as a secondary visual layer via the user interface 1108, which may provide the human agent with real-time guidance without interrupting the primary workflow execution.

In yet another embodiment, processor 1106 may manage the computing efficiency of a head-to-head challenge. By allocating dedicated processing cycles to both agents and utilizing high-speed memory 1104 to track segment-level performance in real-time, the system may determine which agent's segment should be prioritized for the user interface. This hardware-governed competitive environment may ensure that high-quality data segments may consume the final output bandwidth, effectively reducing storage and transmission waste for suboptimal information.

FIG. 12 is a detailed hardware architecture diagram illustrating the integration of hardware sensors, system memory modules, and agent evaluation logic for performing the embodiments and processes discussed herein, in accordance with some embodiments of the disclosure. In some embodiments, FIG. 12 may provide a granular view of the technical environment 1200 supporting the multi-agent electronic platform. This architecture may facilitate the high-speed synchronization of parallel human and AI data streams by intertwining physical sensor inputs with specialized processing units and memory structures that may be designed for real-time task completion detection and response arbitration.

In one or more embodiments, the example environment 1200 for implementing the multi-agent synchronization and evaluation aspects described herein may include a computer 1202. The computer 1202 may include a processing unit 1204, a system memory 1206, and a system bus 1208. The system bus 1208 may couple system components including, but not limited to, the system memory 1206 to the processing unit 1204. Processing unit 1204 may be any of various commercially available processors, including those optimized for executing the AI agent module 117 or the unbiased AI orchestrator 438. Dual microprocessors and other multi-processor architectures may also be employed as the processing unit 1204 to facilitate the parallel execution 404 of human and AI response threads.

In some embodiments, the system memory 1206 may include ROM 1210 and RAM 1212. The RAM 1212 may serve as a high-speed cache for data 1236 and modules 1234, such as the Hardware Sensor Integration Logic 1205. This memory structure may be critical for managing the hardware-governed buffering period 240, as it may allow the system to hold a first response thread in a low-latency state while awaiting the arrival of a second thread. By managing the buffer in high-speed RAM 1212, the system may ensure that the evaluation module may access both responses simultaneously, or within a predetermined time threshold, without introducing traditional I/O delays.

The computer 1202 may further include an internal hard disk drive (“HDD”) 1214, which may store the Ranking DB 1040 or the enterprise knowledge base 350. In some embodiments, HDD 1214 may store the Agent evaluation and ranking logic, which may be executed by processing unit 1204 to update agent profiles 680 based on user adoption data. External storage devices 1216, such as flash drives or network-attached storage, may also be connected via an interface 1226 to store large datasets that may be used for training responding to AI models 1045.

In some embodiments, computer 1202 may include an optical drive 1220 for reading or writing to a disk 1222 via an interface 1228. These storage components, along with the HDD 1214, may provide non-volatile storage for the operating system 1230 and application programs 1232, which may include the human agent interface 115 and the AI agent module 117.

A human agent may enter commands and information into the computer 1202 through one or more wired/wireless input devices, such as a keyboard 1238, a touch screen 1240, and a pointing device like a mouse 1242. To facilitate the interruption detection described in FIG. 4, the computer 1202 may be operatively coupled to hardware sensors 1244. These sensors 1244 may include a mouse/keyboard activity monitor 1244 and a system analytics module to track real-time CPU/RAM usage 420. In another embodiment, the hardware sensors 1244 may include biometric devices like the laptop camera 530 for tracking gaze or a wearable smartwatch 540 for heart rate monitoring and detecting human activity indicative of the human agent still thinking and processing in a wait-state.

In some embodiments, the input devices may be connected to the processing unit 1204 through various interfaces 1224, 1226, 1228 coupled to the system bus 1208. A monitor 1246 or other display device may be connected via a video adaptor 1248 to provide the user display interface 160. This adaptor 1248 may support the rendering of the final response 145 and the interactive toggle 845, which may allow for visually differentiated segments 840 to be displayed to the user.

Computer 1202 may operate in a networked environment using logical connections to one or more remote computer(s) 1250. The remote computer(s) 1250 may include memory/storage 1252 to store additional agent performance data. Logical connections may include connectivity to a local area network (“LAN”) 1254 and larger networks like a wide area network (“WAN”) 1256. A modem 1260 or network adaptor 1258 may facilitate communication over WAN 1256 or LAN 1254, respectively, supporting collaborative consultation detection 635 between distributed agents.

An example of use of process in FIG. 12, in addition to the embodiments of FIGS. 1-10, may include a human agent 510 drafting a response while an AI agent concurrently generates an alternative. The processing unit 1204 may manage both threads, while the Hardware Sensor Integration Logic 1205 may monitor the mouse 1242 and keyboard 1238 activity via the hardware sensors 1244. If the agent may pause, the processing unit 1204 may check the system memory 1206 for current RAM usage 1212 and may analyze heart rate data from a smartwatch interface to determine if the agent may be in a thinking mode. Once the responses may be synchronized in the high-speed RAM 1212 buffer, the agent evaluation logic 1214 may score the inputs. The final response may then be rendered via the video adaptor 1248 on monitor 1246, which may allow the end user to interact with the multi-agent output.

In another embodiment, the system may utilize the network adapter 1258 to establish a picture-in-picture simulation 490 or sandbox simulation described herein. While the primary processing unit 1204 may handle the live query, a remote computer 1250 may run a background AI simulation, which may transmit visual cursor movements back to monitor 1246 to guide the human agent in real-time.

In yet another embodiment, the hardware sensors 1244 may include advanced biometric sensors capable of detecting brain activity or sweat gland fluctuations. These signals may be tokenized and may be stored in RAM 1212 to authenticate that a response segment was authored by a human in a high-focus cognitive state, thereby potentially providing a hardware-verified expertise rating that the AI orchestrator may use to weigh the response more heavily during evaluation.

In addition to the details described in FIGS. 1-12, the embodiments described herein provide a technical framework for managing multi-agent query processing by coordinating human and AI inputs through parallel, synchronized architecture. When a live query is received, the system simultaneously initiates independent workflows for a human agent and an AI agent, ensuring the AI's work remains hidden from the human to maintain the integrity of the human's independent cognizance. Both responses are held in a hardware-managed buffering period, allowing a second, unbiased AI agent, which is blind to the source of each response, to objectively evaluate the threads based on factors like empathy, compliance, and coherence. The system may automatically select the AI's response if the human is delayed or prioritize the human's input if it meets specific quality thresholds. Furthermore, the AI can act as a quality assurance layer by identifying inaccuracies in the human's draft and surgically replacing them with corrected enterprise data to form a modified final response.

To ensure the highest quality output, the system may utilize a dynamically shifting evaluation threshold that adjusts based on the query's technical nature, the importance of the task, or the seniority of the user who submitted the request. The selection process may also weigh a human agent's input more heavily based on their specific title or expertise, provided they do not attempt to bypass the system by using unauthorized external AI platforms. In sophisticated hybrid embodiments, the system uses large language models to parse responses into distinct segments, identifying key segments where human expertise is critical (such as high-impact financial or regulatory content) and combining them with AI-generated “non-key segments” for technical precision. This combination logic ensures the final output is both coherent and adheres to specific enterprise rules regarding the required ratio of human-to-AI content.

The final response may be displayed with clear visual differentiation, such as color-coding or highlighting, to denote the source of different portions, and includes an interactive toggle that allows the end user to switch between human and AI versions on a segment-by-segment basis. User interactions, such as accepting a response or requesting changes, are tracked to rank both agents on a sliding scale. This data is aggregated over time to generate detailed performance reports for human agents, offering personalized feedback and learning resources derived from AI alternatives to foster continuous professional development.

It will be apparent to those of ordinary skill in the art that methods involved in the above-mentioned embodiments may be embodied in a computer program product that includes a computer-usable and/or-readable medium. For example, such a computer-usable medium may consist of a read-only memory device, such as a CD-ROM disk or conventional ROM device, or a random-access memory, such as a hard drive device or a computer diskette, having a computer-readable program code stored thereon. It should also be understood that methods, techniques, and processes involved in the present disclosure may be executed using processing circuitry.

The processes discussed above are intended to be illustrative and not limiting. More generally, the above disclosure is meant to be exemplary and not limiting. Only the claims that follow are meant to set bounds as to what the present invention includes. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

What is claimed is:

1. A method comprising:
receiving a live query on an electronic platform;
simultaneously generating a human agent response and an artificial intelligence (AI) agent response for the received query, wherein the AI agent response is hidden from the human agent;
buffering the human agent response and the AI agent response for a predetermined interval;
evaluating the human agent response and the AI agent response during the buffering;
selecting a final response from the human agent's response, the AI agent's response, or a combination thereof, based on the evaluation; and
displaying the final response on the electronic platform.

2. The method of claim 1, further comprising, introducing the predetermined interval after generating the human agent response and the AI agent response for buffering the human agent response and the AI agent response.

3. The method of claim 1, further comprising:
analyzing the human agent response by the AI agent;
identifying inaccuracies or outdated information within the human agent response;
automatically generating a corrected or updated portion of the response by the AI agent;
replacing the identified inaccuracies or outdated information in the human agent response with the corrected or updated portion; and
providing the resulting modified human agent response as the final response.

4. The method of claim 1, wherein selecting the final response from the human agent's response, the AI agent's response, or the combination thereof, further comprises, automatically selecting the AI agent response if its evaluation score exceeds a first predefined threshold and the human agent's response is not yet received, or automatically selecting the human agent response if its evaluation score exceeds a second predefined threshold and the AI agent's score is below the human agent's score.

5. The method of claim 1, further comprising:
scoring the human agent response and the AI agent response; and
selecting the final response based on comparing scores from scoring the human agent response and the AI agent response to a dynamically shifting threshold, wherein the dynamically shifting threshold is determined based on at least one factor selected from a group consisting of: a nature of the live query, a task being performed associated with the live query, and a title or role of a user who submitted the live query.

6. The method of claim 1, wherein selecting the final response further comprises:
determining that the human agent used an external AI platform to generate their response; and
automatically selecting the AI agent response over the human agent response based on the human agent's use of the external AI platform.

7. The method of claim 1, wherein selecting a final response as a combination of the human agent's response and the AI agent's response further comprises:
identifying a key segment of the human agent's response based on the human agent's expertise or title;
adopting the human agent's response related to the key segment; and
adopting the AI agent's response for non-key segments to form the combination.

8. The method of claim 7, wherein identifying a key segment of the human agent's response further comprises:
parsing the human agent's response into a plurality of distinct segments;
analyzing each distinct segment to determine a key segment identifier, wherein a non-key segment identifier is automatically assigned to any segment not tagged with a key segment identifier; and
selecting the human agent's response only for the segment(s) identified with the key segment identifier, and selecting the AI agent's response for the segment(s) identified with the non-key segment identifier to form the combination.

9. The method of claim 8, wherein analyzing each distinct segment to determine the key segment identifier is performed by a Large Language Model (LLM), and wherein the LLM is configured to automatically tag a segment with the key segment identifier or the non-key segment identifier based on an analysis of the segment's content against a predefined criterion.

10. The method of claim 1, wherein combining the human agent response and the AI agent response includes:
applying a rule to ensure the combined response is coherent and logically flows; and
applying a combining rule specifying a required percentage of the human agent response and a required percentage of the AI agent response to be included.

11. The method of claim 1, wherein displaying the final response on the electronic platform further comprises, providing an interactive option to allow toggle back and forth between the final response and an alternative response (the original human agent response or the original AI agent response) on a segment-by-segment basis or a full response basis.

12. The method of claim 1, further comprising, ranking the human agent and the AI agent based on a user's subsequent action, wherein the user's subsequent action is selected from the group consisting of accepting the final response or asking for clarification or changes to the final response.

13. The method of claim 12, wherein ranking the human agent and the AI agent comprises:
increasing the rank of the agent responsible for the final response when the user's subsequent action is accepting the final response; and
decreasing the rank of the agent responsible for the final response when the user's subsequent action is asking for clarification or changes.

14. The method of claim 12, wherein ranking of the human agent and the AI agent is based on a sliding scale score, wherein the sliding scale score is adjusted in a range between a maximum score and a minimum score, and is determined by the degree of acceptance or modification requested by the user's subsequent action

15. The method of claim 14, further comprising:
aggregating the sliding scale scores for a plurality of queries handled by the human agent over a defined period; and
automatically generating a performance report for the human agent based on the aggregated sliding scale scores, wherein the performance report includes personalized feedback explaining why specific response portions were scored below a predetermined threshold and providing resources to learn from the AI agent's alternative responses.

16. A system comprising:
a processor configured to:
receive a live query on an electronic platform;
simultaneously generate a human agent response and an artificial intelligence (AI) agent response for the received query, wherein the AI agent response is hidden from the human agent;
buffer the human agent response and the AI agent response for a predetermined interval;
evaluate the human agent response and the AI agent response during the buffering;
select a final response from the human agent's response, the AI agent's response, or a combination thereof, based on the evaluation; and
display the final response on the electronic platform.

17. The system of claim 16, further comprising, the processor configured to:
analyze the human agent response by the AI agent;
identify inaccuracies or outdated information within the human agent response;
automatically generate a corrected or updated portion of the response by the AI agent;
replace the identified inaccuracies or outdated information in the human agent response with the corrected or updated portion; and
provide the resulting modified human agent response as the final response.

18. The system of claim 16, wherein selecting the final response from the human agent's response, the AI agent's response, or the combination thereof, further comprises, the processor configured to automatically select the AI agent response if its evaluation score exceeds a first predefined threshold and the human agent's response is not yet received, or automatically select the human agent response if its evaluation score exceeds a second predefined threshold and the AI agent's score is below the human agent's score.

19. The method of claim 1, further comprising, the processor configured to:
score the human agent response and the AI agent response; and
select the final response based on comparing scores from scoring the human agent response and the AI agent response to a dynamically shifting threshold, wherein the dynamically shifting threshold is determined based on at least one factor selected from a group consisting of: a nature of the live query, a task being performed associated with the live query, and a title or role of a user who submitted the live query.

20. The system of claim 16, wherein displaying the final response on the electronic platform further comprises, the processor configured to provide an interactive option to allow toggle back and forth between the final response and an alternative response (the original human agent response or the original AI agent response) on a segment-by-segment basis or a full response basis.
